(19) United States
(12) Patent Application Publication
(10) Pub. No.: US 2014/0160777 A1
(43) Pub. Date: Jun. 12, 2014

(54) LIGHTING DEVICE FOR VEHICLES

(71) Applicant: Hella KGaA Hueck & Co., Lippstadt (DE)

(72) Inventor: Martin Mügge, Geseke (DE)

(73) Assignee: Hella KGaA Hueck & Co., Lippstadt (DE)

(21) Appl. No.: 14/098,102

(22) Filed: Dec. 5, 2013

(30) Foreign Application Priority Data
Dec. 11, 2012 (DE) 102012112075.7

(51) Int. Cl. F21S 8/10

(52) U.S. Cl. CPC F21S 48/00
USPC 362/508

(57) ABSTRACT

A lighting device includes a first lamp unit mountable on a first body part and a second lamp unit mountable on a second body part and movable relative to the first body part, wherein a gap is formed between the first and second lamp units, the first and second lamp units each have a housing with light sources and covered by a transparent lens, wherein the lens has a base surface for transmitting a functional light beam in the main beam direction and a side section that borders the gap and runs parallel to a gap plane and through which a side light beam enters into the gap, wherein the side section of the lens and/or a light guiding part covered by the lens has scattering elements, so that the side light beam emitted by the light source can be emitted along the gap plane in the main beam direction.

### CROSS REFERENCE

This application claims priority to German Patent Application No. 10 2012 112075.7, filed Dec. 11, 2012.

### TECHNICAL FIELD OF THE INVENTION

The invention relates to a lighting device for vehicles with a first lamp unit that can be mounted on a first body part and with a second lamp unit that can be mounted on a second body part that can move relative to the first body part, wherein a gap is formed between the first lamp unit and the second lamp unit, the first lamp unit and the second lamp unit each have a housing with a number of light sources, and each housing is covered by a transparent lens, wherein the lens has a base surface covering the housing for transmitting a functional light beam in the main beam direction and a side section that borders the gap and runs parallel to a gap plane and through which a side light beam emitted from the light source enters into the gap.

### BACKGROUND OF THE INVENTION

From DE 10 2004 043 045 A1, a lighting device for vehicles is known that has two lamp units that are physically separated. A first lamp unit is fastened to a stationary first body part. A second lamp unit is fastened to a movable second body part, for example, on a tail gate or a trunk lid. The first lamp unit is angled and extends at a relatively acute angle relative to the longitudinal axis of the vehicle. So that the light emitted from this first lamp unit can also be emitted in the longitudinal direction of the vehicle, a side section of a lens of the first lamp unit that is directed toward a gap extending between the first lamp unit and the second lamp unit has a transparent construction. The known lighting device thus allows a side light emission toward the first lamp unit and thus also laterally to the gap. If the first lamp unit and the second lamp unit are located on the rear side of a vehicle, wherein transparent lenses of the first lamp unit and the second lamp unit are essentially perpendicular to the longitudinal axis of the vehicle, then this produces the problem that, due to the necessary spacing between the two lamp units relative to each other, a gap is visible between these lamp units from behind and this gap negatively affects the homogeneous appearance of the lighting device. Due to the gap there is a visible break in the lighting device and this break is not wanted for aesthetic reasons.

The problem of the present invention is therefore to refine a lighting device for vehicles with a first lamp unit and a second lamp unit arranged separated from the first lamp unit by a gap such that a uniform appearance of the two lamp units is guaranteed in a simple way.

### SUMMARY OF THE INVENTION

To solve this problem, the side section of the lens and/or a light guiding part covered by the lens has scattering elements so that the side light beam emitted by the light source can be emitted along the gap plane in the main beam direction.

The special advantage of the invention consists in that, through the arrangement of scattering elements in the area of a gap between a first lamp unit and a second lamp unit, light is deflected or scattered so that the gap itself is illuminated by a side light beam. The scattering elements have the effect that the side light beam runs in the direction of the gap between the two lamp units and can be output there. In this way, the two illuminating lenses of the adjacent lamp units are visually “connected” to each other by the emission of the side light beam in the gap. The scattering element can be an integral part of the lens and/or of an additional light guiding part that is arranged within a housing of the first lamp unit and/or the second lamp unit. The invention makes it possible that the gap is perceived as an illuminated area even at a relatively acute observation angle relative to an optical axis of the lamp units or relative to the longitudinal axis of a vehicle. Here, the invention takes advantage of the fact that an observer never views the first lamp unit and the second lamp unit from the same observation angle.

According to one preferred embodiment of the invention, the light guiding part is constructed as a flat or rod-shaped light conductor in which a side surface is provided with the scattering element on a side facing the gap. Additionally or alternatively, an additional diffusing lens can be arranged between the light conductor or another lamp unit of the lighting device on one side and a side section of the lens on the other side. Such an additional diffusing lens is useful especially when the light conductor is constructed without optical elements on a side facing the gap or has smooth surfaces. Depending on the light configuration or the installation space, a side scattering of the light can be realized that leads to an illumination of the gap. The lighting device thus gives a uniform optical character.

According to one preferred embodiment of the invention, the lighting device has only one light conductor provided with one optical element, wherein the side section of the lens can be constructed without optical elements or with smooth surfaces. In terms of production, the illumination of the gap can be realized easily by a light guiding part that is also responsible for distributing the light in the direction of the front side of the lamp unit. Guiding the light in the main beam direction is thus realized completely by the light conductor.

According to one refinement of the invention, the rear side of the light conductor can have parabolic reflection surfaces and/or additional or other optical elements that guide a portion of the input light in the direction of the gap. In this way, an increased optical flux can be guided in the direction of the gap.

According to one refinement of the invention, the side surface of the light conductor facing the gap is constructed with wave-shaped contours in the main beam direction, so that the gap illumination can be optimized.

According to one refinement of the invention, the light conductor can be made from a transparent material provided with scattering particles instead of from a transparent material in order to increase the scattering effect. This arrangement further improves the homogenization of the light beam direction towards the front or towards the side.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a front view of a lighting device constructed as a rear lamp,

FIG. 2 a horizontal section through the lighting device according to FIG. 1 in a gap area with a first lamp unit and a second lamp unit according to a first embodiment of the invention,

FIG. 3 a horizontal section through the lighting device according to FIG. 1 in a gap area with a first lamp unit and a second lamp unit according to a second embodiment of the invention,

FIG. 4 a horizontal section through the lighting device according to FIG. 1 in a gap area with a first lamp unit and a second lamp unit according to a third embodiment of the invention, and

FIG. 5 a horizontal section through the lighting device according to FIG. 1 in a gap area with a first lamp unit and a second lamp unit according to a fourth embodiment of the invention.

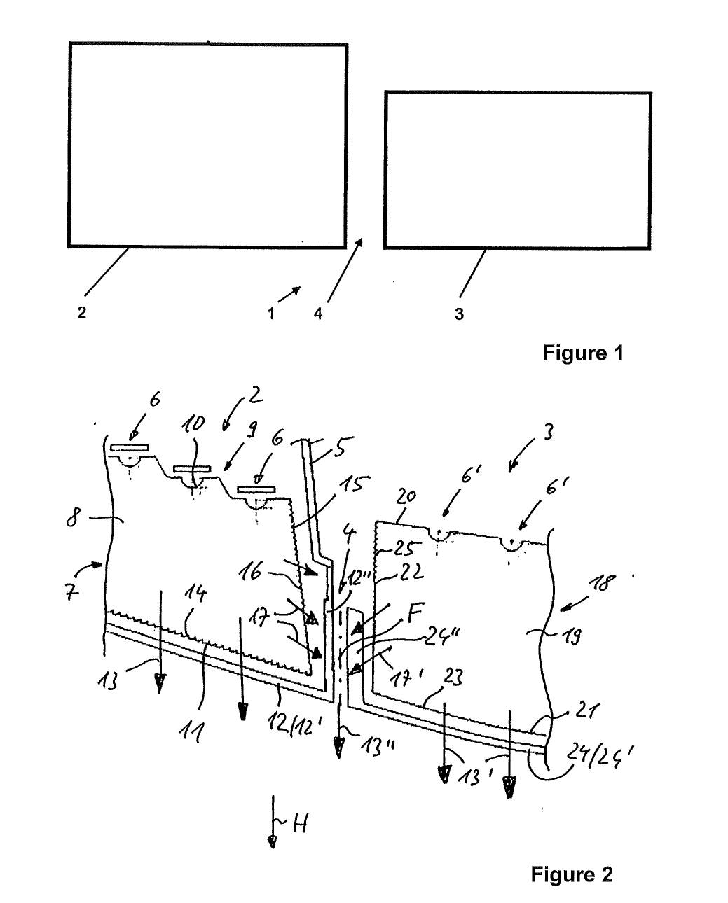

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

The invention relates to a lighting device 1 for vehicles that is advantageously constructed as a two-part rear lamp and is used for generating a tail lamp, brake light, or turn signal function. Alternatively, the lighting device according to the invention can also be arranged in a front area of a motor vehicle.

The two-part rear lamp 1 has a first lamp unit 2 that is mounted on a stationary first body part of the motor vehicle, for example, on a side panel of the motor vehicle. Furthermore, the rear lamp has a lamp unit 3 that can move relative to the first lamp unit 2 and is mounted on a movable second body part, for example, a tail gate or trunk lid. A gap 4 extends between the first lamp unit 2 and the second lamp 3 or between the stationary first body part and the movable second body part. This gap 4 extends essentially in the vertical direction.

The first lamp unit 2 has a housing with a pot-shaped housing wall 5 in which a number of light sources and light guiding parts are arranged, for example, reflectors, light conductors for generating different lighting functions, for example, tail lamp, brake light, and turn signal functions. FIG. 2 shows the first lamp unit 2 and the second lamp unit 3 for generating a tail lamp function.

The first lamp unit 2 has a pot-shaped housing with a housing wall 5 in which a number of LED light sources 6 are arranged in a row. In the main beam direction H in front of the LED light sources 6, a plate-shaped light conductor 7 is arranged as a light guiding part that provides two opposing parallel flat sides 8 that totally reflect the light of the LED light sources 6 input at a rear narrow side 9. For the targeted input of the light, the rear narrow side 9 has recesses that are allocated to each of the LED light sources 6 and are used as light input surfaces 10. A front narrow side 11 opposite the rear narrow side 9 is used as a light output surface for a first tail lamp light beam 13 emitted into the surroundings through a base surface 12′ of a transparent lens 12 covering the housing opening of the first lamp unit 2. While the base surface 12′ of the lens 12 is constructed without optical elements, the light output surface 11 is provided with scattering elements 14, so that the tail lamp light beam 13 is emitted more homogeneously.

Furthermore, on a side facing the gap 4, the plate-shaped light conductor 7 has a narrow side surface 15 that is provided with scattering elements 16, so that a side light beam 17 of the first lamp unit 2 running perpendicular to the main beam direction H is scattered and emitted in the direction of a gap plane F toward the front side of the lighting device 1.

The side surface 15 of the light conductor 7 is used as a side light output surface for the side light beam 17 that passes through a side section 12″ of the lens 12 that is free from optical elements and is essentially parallel to the gap plane F. The side section 12″ of the lens 12 has a length that is greater than half the length of the side surface 15 of the light conductor 7, so that a side illumination of the gap 4 can be realized over a relatively large gap depth. A free end of the side section 12″ of the lens 12 is connected rigidly to the housing wall 5, for example, by vibration welding. The gap plane F runs in the vertical direction and forms a center plane of the gap 4 that can be, for example, 20 mm to 25 mm wide.

The second lamp unit 3 has—like the first lamp unit 2—a housing in which a plurality of LED light sources 6′ are arranged in a row. In the main beam direction H in front of the LED light sources 6′ there is a plate-shaped light conductor 18 that has parallel flat sides 19, a rear narrow side 20, a front narrow side 21, and a side surface 22 arranged on a side facing the gap 4. The rear narrow side 20 is used for the input of the light that is emitted by light sources 6′ and is totally reflected at the flat sides 19. The front narrow side 21 is used as a light output surface for a second tail lamp light beam 13′ that is emitted in the main beam direction H for generating the tail lamp light. The front narrow side 21 has scattering elements 23 for homogenizing the tail lamp light beam 13′. In the main beam direction H in front of the plate-shaped light conductor 18 there is an optical element-free lens 24 that has a base surface 24′ running perpendicular to the main beam direction H or gap plane F and a side section 24″ that runs in the direction of the gap plane F or the main beam direction H and faces the gap 4. The side surface 22 of the light conductor 18 has scattering elements 25 so that a side light beam 17′ is scattered for illuminating the gap 4 and can be emitted towards the front in the direction of the gap plane F.

Thus, when the tail lamp light function is turned on, the first tail lamp light beam 13 is emitted through the base surface 12′ of the lens 12 of the first lamp unit 2 and the second tail lamp light beam 13′ is emitted through the base surface 24′ of the lens 24 of the second lamp unit 3 in the main beam direction H. In addition, in the area of the gap between the first lamp unit 2 and the second lamp unit 3, the first side light beam 17 and the second side light beam 17′ are emitted as the light beam 13″ for illuminating the gap 4 in the main beam direction H. This produces a continuous emitted surface including the gap 4.

The lenses 12, 24 are transparent and preferably tinted red.

The scattering elements 16, 25 are constructed as cylindrical optical elements that extend adjacent to each other in the vertical direction in a strip-like shape. The scattering elements 14, 23 of the respective lenses 12 and 24 are constructed as cylindrical optical elements. According to one not-shown alternative embodiment, the scattering elements can also be constructed by prism-shaped or cushion-shaped optical elements.

According to one not-shown alternative embodiment, only one of the two light conductors 7, 18 can also be provided on the side facing the gap 4 with scattering elements 16, 25.

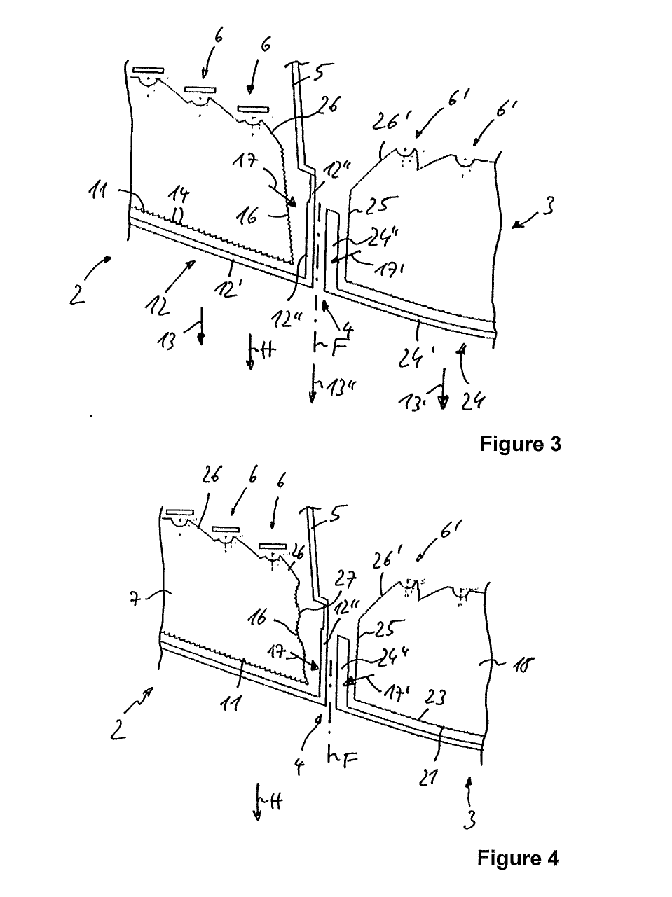

According to a second embodiment of the invention according to FIG. 3, the light conductors 7, 18 of the lamp unit 2, 3 can have, in contrast to the embodiment according to FIG. 2 on the respective rear narrow sides 9 and 20, respective parabolic reflection surfaces 26 and 26′ that run adjacent to the light input surfaces 10 and allow an improved guidance of the input light in the direction of the gap 4. Alternatively, instead the parabolic reflection surfaces 26, 26′, other optical elements can also be arranged on the rear narrow side 9, 20 of the light conductor 7 and 18, respectively.

Components and/or component functions that are the same in the different embodiments are provided with the same reference symbols.

According to another embodiment of the invention according to FIG. 4, in contrast to the embodiment according to FIG. 3, the side surface 15 of the plate-shaped light conductor 7 can have a wave-shaped contour 27 that runs in the main beam direction H and realizes improved light deflection in the gap area. Alternatively, the side surface 15 of the light conductor 7 can also have a discontinuous contour in the main beam direction H.

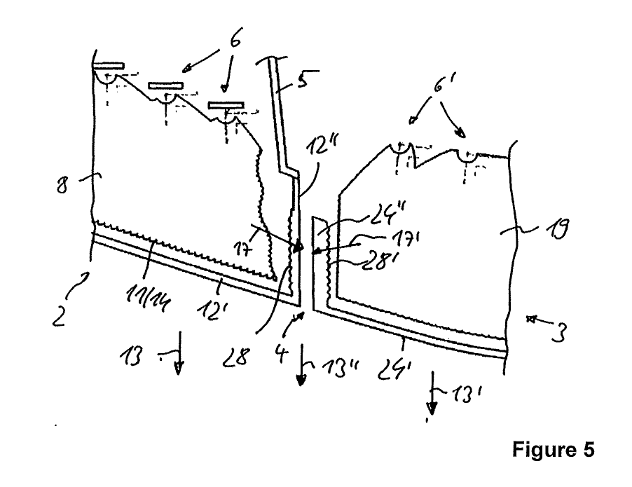

According to another embodiment of the invention according to FIG. 5, in contrast to the embodiment according to FIG. 4, the side sections 12″, 24″ of the respective lenses 12 and 24 can be provided with scattering elements 28, 28′ in order to enable improved illumination of the gap 4. The scattering elements 28, 28′ are constructed as strip-shaped, cylindrical optical elements that extend in the vertical direction. Alternatively, these scattering elements 28, 28′ can also be constructed as cushion-shaped or prism-shaped optical elements.

According to an additional not-shown embodiment, the light conductor can also have a rod-shaped, straight, and/or bent construction.

Alternatively, the scattering elements 16, 25, 28, 28′ of the light conductors 7, 18 and the side sections 12″, 24″ of the respective lenses 12 and 24 can also be provided with an eroded or etched structure for diffuse scattering.

Advantageously, the light conductor 7, 18 also consists of a transparent light-conducting plastic or glass material.

According to an alternative embodiment of the invention, the light conductor 7, 18 can also be made from a light-conducting material provided with scattering particles preferably in the nanometer range.

Additional not-shown embodiments are given from the combination of the features listed above.

According to one additional alternative embodiment of the invention, an additional diffusing lens that is provided with scattering elements can be arranged between the side section of the light conductor and the side surface of the lens. Alternatively, the additional diffusing lens could also be arranged between a different lamp unit of the lighting device and the lens covering the pot-shaped housing.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SYMBOLS

1 Lighting device
2 First lamp unit
3 Second lamp unit
4 Gap
5 Housing wall
6, 6′ LED light source
7 Flat light conductor
8 Flat side
9 Rear narrow side
10 Light input surface
11 Front narrow side
12, 12′ Lens, base surface, side section
13, 13′ Tail lamp light beam
14 Scattering elements
15 Side surface
16 Scattering elements
17, 17′ Side light beam
18 Flat light conductor
19 Flat sides
20 Rear narrow side
21 Front narrow side
22 Side surface
23 Control elements
24, 24′, 24″ Lens, base surface, side section
25 Scattering elements
26, 26′ Reflection surfaces
27 Wave-shaped contour
28, 28′ Scattering elements
H Main beam direction
F Gap plane

1. A lighting device for vehicles, comprising:
a first lamp unit that can be mounted on a first body part and a second lamp unit that can be mounted on a second body part that can move relative to the first body part, wherein a gap is formed between the first lamp unit and the second lamp unit,
the first lamp unit and the second lamp unit each have a housing with a number of light sources and each housing is covered by a transparent lens, wherein the lens has a base surface covering the housing for transmitting a functional light beam in the main beam direction and a side section that borders the gap and runs parallel to a gap plane and through which a side light beam emitted from the light source enters into the gap,
wherein the side section of the lens and/or a light guiding part covered by the lens has scattering elements, so that the side light beam emitted by the light source can be emitted along the gap plane in the main beam direction.

2. The lighting device according to claim 1, wherein the light guiding part is constructed as a flat or rod-shaped light conductor with a side surface running parallel to the side section of the lens or is constructed as an additional diffusing lens running parallel to the side section of the lens.

3. The lighting device according to claim 2, wherein the side surface of the light conductor provided with the scattering elements is arranged on a side facing the gap.

4. The lighting device according to claim 2, wherein the flat light conductor has two opposing flat sides at which the input light can be reflected totally and which are bordered laterally by the side surface, wherein the side surface extends from a rear narrow side to a light output front narrow side of the flat light conductor.

5. The lighting device according to claim 4, wherein a number of light sources is arranged on the rear narrow side of the flat light conductor for the input of the light into the flat light conductor.

6. The lighting device according to claim 1, wherein the scattering elements are formed by a number of optical elements that are strip-shaped or cylindrical or cushion-shaped or prism-shaped.

7. The lighting device according to claim 4, wherein the rear narrow side of the flat light conductor has parabolic reflection surfaces such that a portion of the input light is guided in the direction of the gap.

8. The lighting device according to claim 2, wherein the side surface of the light conductor has a wave-shaped contour or a discontinuous profile in the direction of the main beam direction.

9. The lighting device according to claim 1, wherein the light guiding part consists of a transparent material or a material provided with scattering particles.

10. The lighting device according to claim 1, characterized in that a light output surface of the light guiding part is provided with scattering elements.

11. The lighting device according to claim 1, wherein the light guiding part is constructed as an additional diffusing lens running parallel to the side section of the lens.
